(19) United States
(12) Patent Application Publication
(10) Pub. No.: US 2015/0317406 A1
(43) Pub. Date: Nov. 5, 2015

(54) Re-Use of Web Page Thematic Elements

(71) Applicant: David P. Bort, Palo Alto, CA (US)

(72) Inventor: David P. Bort, Palo Alto, CA (US)

(21) Appl. No.: 12/343,695

(22) Filed: Dec. 24, 2008

(51) Int. Cl. G06F 3/00; G06F 3/0484; G06F 17/21

(52) U.S. Cl. CPC G06F 17/30905; G06F 17/212; G06F 17/30896; G06F 3/04842

(57) ABSTRACT

The subject matter of this specification can be embodied in, among other things, a computer-implemented method that includes electronically displaying a web page with a web browser to a user of a first computing device; receiving a selection from the user to capture formatting information from the web page; and automatically applying the formatting information to one or more applications associated with a user of the first computing device.

### TECHNICAL FIELD

This document describes systems and techniques for generating formatting and other thematic elements for a web page from another web page that is identified by a user of a computing device.

### BACKGROUND

The World Wide Web continues to grow as a mechanism by which people can communicate with each other and can otherwise express themselves. Via ordinary web pages, blogs, personal pages, social networking sites, and other forms of web pages, people can distribute information on important topics or can simply ramble on about points that interest them.

Web design and layout can be an important factor in communicating a point in a web page. In particular, the manner in which information is presented can determine the level to which a reader comprehends the information. Even color can have an effect on comprehension, and with the manner in which a user experiences a particular page. For example, a user visiting a page filled with pink and purple graphics likely has a different expectation than a user faced with a page filled with nothing more than blue and gray. Many web page designers spend as much effort on achieving an appropriate look for their page as they do on the actual content of the page.

### SUMMARY

This document describes systems and techniques by which certain web design elements can be re-used from one web page to another. For instance, a person may want their social networking page to look somewhat like that of a close friend, and after getting permission from the friend, may point her web browser at the friend's page and select to re-use certain design elements from the friend's page. For example, the style sheet for the friend's page and other formatting elements may be analyzed to determine the elements that affect the look of the page. Those elements may be encoded in a new, different page, which the user may then complete by filling it with content. The user may also alter the contents so as to make the format of the content match their desires. For example, a user may employ a color scheme that is similar to their friend's color scheme, and may also use similar fonts, but may change the general layout of elements on the page. The transfer of elements may occur simply by the user pointing their browser at the friend's page and selecting a control for transferring the formatting information. Also, the act of transferring the information may cause a message to be transferred to the owner of the page (e.g., by parsing an e-mail address from the page or from associated pages, such as pages in the same path as the page) so that the owner is informed that a transfer of such elements has occurred.

In a first general aspect, a computer-implemented method is described. The method includes electronically displaying a web page with a web browser to a user of a first computing device; receiving a selection from the user to capture formatting information from the web page; and automatically applying the formatting information to one or more applications associated with a user of the first computing device.

In a second general aspect, a computer-implemented system is described. The system includes a web browser to display web pages on a computing device; style sheet storage storing formatting information for the displayed web pages; and a web page format extractor to access the style sheet storage and identify values for formatting in the web pages and automatically make the values available for use by applications other than the web browser.

In a third general aspect, a computer-implemented system is described. The system includes a web browser to display web pages; style sheet storage storing formatting information for the displayed web pages; and means for automatically extracting formatting information from the style sheet storage and make the formatting information available for use by applications other than the web browser.

The details of one or more embodiments are set forth in the accompanying drawings and the description below. Other features, objects, and advantages will be apparent from the description and drawings, and from the claims.

### DESCRIPTION OF DRAWINGS

FIG. 1A shows a conceptual diagram of a system 100 for re-using layout components of a web page.

FIGS. 1B and 1C show examples flows by which elements from a web page may be used in a messaging application.

FIG. 2A is a flow chart of a process for providing formatting information from a first web page to a second web page.

FIG. 2B is a swim lane diagram of a process for moving formatting information from one device to another.

FIG. 3 is a schematic diagram of a wireless communication handset for generating requests and receiving and using information generated in response to those requests.

FIG. 4 shows an example of a computer device and a mobile computer device that can be used to implement the techniques described here.

Like reference symbols in the various drawings indicate like elements.

### DETAILED DESCRIPTION

In general, this document describes mechanisms for using formatting information from one web page or other similar document in another web page or document. The formatting information may be re-used, in one example, by a user simply visiting a page with their browser and then selecting a control that recreates certain identified formatting information from the selected page onto a different page. The formatting information may come, in whole or in part, from a style sheet associated with the initial page. For example, an application may be run separately from or as a plug in to a user's browser. The application may generate a selectable control that, when selected, causes code for the page currently displayed in the browser to be analyzed and parsed. Such code may then be transferred to another application, such as a web page editor, where the user may manipulate it (and add content to it) before displaying content with the formatting in another page.

A user can also point to a first page and select the page with the application, and then navigate to a second page, to have portions of the formatting for the first page applied to the second page while the user views the second page. The formatting changes may be applied only to the manner in which the second page is rendered on the user's device at that time, and may not change the actual code underlying the second page. The user may also have the same sort of formatting changes applied to other subsequent pages they visit. In this manner, a user may have various pages reformatted for their personal review to generally match the look of another page they liked, without affecting the display of the pages for other users.

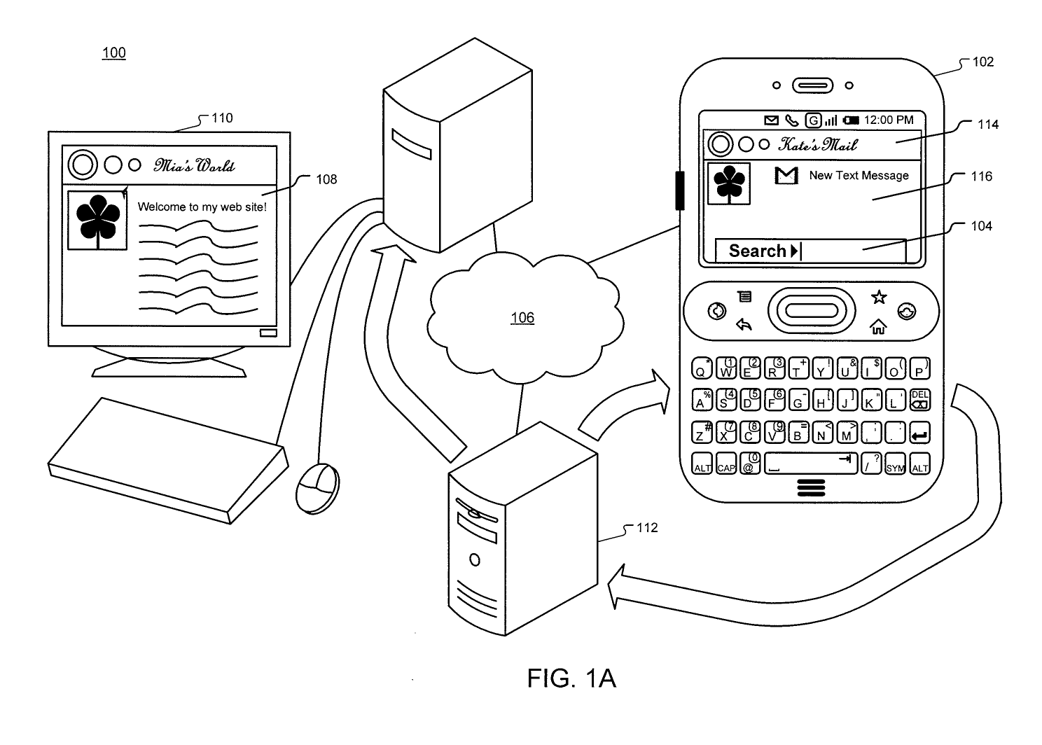

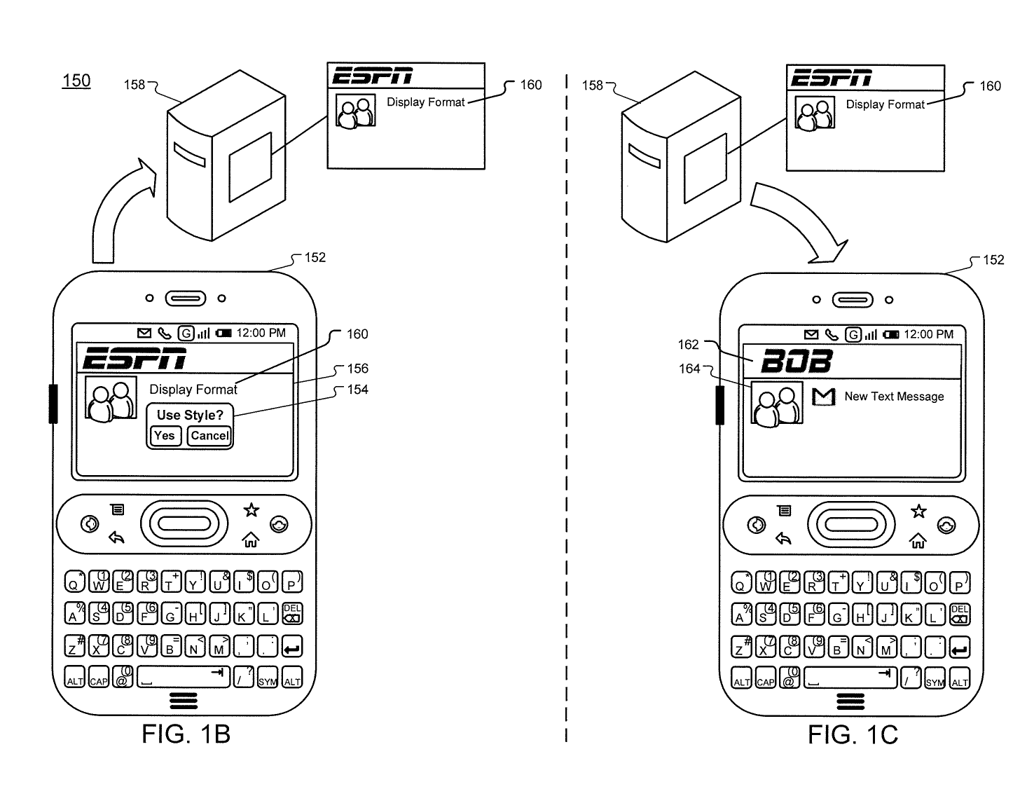

FIG. 1A shows a conceptual diagram of a system 100 for re-using layout components of a web page. In the example system 100, a mobile device 102 is shown running a search application 104. The search application 104 can send a query via a network 106 such as the internet, and can receive search results in response. The search results may include URL's that point to various web pages that are responsive to the submitted query, and the user's selection of hyperlinks for the URL's may cause the corresponding web pages to be displayed on the device 102. In a similar manner, a computer 110 can provide a browser or other application by which a user may enter search queries and may view web pages on various topics, in a familiar manner.

In this example, the web page that is served to computer 110 is served from server 112. The user of the computer 110 may be named Kate, and the page may have been prepared by her friend Mia. In this example, Kate can select an appropriate control, such as by right-clicking on the display 108 of the web page, and selecting a contextual menu selection that copies formatting elements to a file associated with Kate. For example, Kate may be logged onto an on line service from which she obtains e-mail, chat, and other such services. The formatting information may be extracted or scraped from Mia's web page, in a manner discussed in more detail below, and may be stored in a file associated with Kate's account for the on line service. The formatting information may also be rearranged or reinterpreted in a manner so that it can be used with other web pages or software applications.

Mobile device 102 represents another device that Kate owns. The mobile device may be, for example, a wireless smartphone that is provided with a web browser, and through which Kate can access the various services just described. In this example, Kate is using mobile device 102 after she has chosen to scrape information from Mia's web page 108 and have that information stored with her account. As shown on display 114, the mobile device 102 is running an e-mail application in which certain display elements have been re-used from Mia's page. For example, a graphic of three circles in a header of the page is used, as is the font of the page title—though the title here relates to Kate's e-mail and not Mia's page (i.e., the format is the same but the content has changed). Also, a graphic of a shamrock has been reused and is placed in a relative position that matches its location on Mia's web page. Though not visible in the figure, color schemes may also be re-used, where a background color may be used, and one, two or more font colors may also be used. For example, if large fonts on the web page were green and small fonts were white, such colors may be applied to the same relative font sizes in the display 114, such as by using green for the “Kate's Mail” title, and white for the text of e-mails in area 116.

A search box 104 is also shown on display 114. The search box 104 may be used to submit searches on the corpus of e-mails stored for a user. Other search boxes may provide standard web or image or video search results. The ranking of search results may be affected by a user's selection of web pages that they visit. In particular, a user's selection of a page in the manner described above (e.g., by right-clicking on the page and selecting to scrape content or formatting information from the page) can cause the content of the page to be used in generating rankings of search results for the user. For example, a user may select to scrape a page, and the content of the page may be incorporated into an index for a user that is used in ranking search results for the user. In particular, if a user frequently selects to scrape information from automatic web sites, the terms “car” and “automobile” may be added to their personal index by dint of those terms' frequent appearance in the content of automotive web sites. As a result, such terms may be suggestion to a user as they are typing search queries (so that they can easily have the query completed by selecting such suggestions) or may be used to elevate the ranking of search results that include such terms.

Such an approach may permit a user to easily customize their search experience while maintaining a high level of privacy while they surf the web. In particular, a user may choose exactly when terms from a page will be added to an index for improving their suggestions or search results, where the terms may be added only where the user explicitly selects a page. At other times, such indexing may not occur. As a result, when a user is surfing sites that they do not believe to represent their true interests (e.g., because they are surfing aimlessly), they can choose not to scrape the sites, but when they are surfing sites that are central to their interests such as sites that cover the topic of their favorite hobby, they can have terms from the sites added to the personal indexes.

The arrows in FIG. 1A show an example flow of information in the system 100. In particular, a first arrow shows information flowing from server 112 to computer 110. Such a flow may occur, for example, when a user downloads a web page by submitting an HTTP request and receiving, e.g., HTML and CSS code in response. Upon a user selection of a control to scrape content and/or formatting information from the page, the computer 110 may obtain such information and format it in an appropriate manner. The information may then be saved back to a server, such as server 112 or another server when the user of computer 110 is a member of a service provided by a company that differs from the company that provides server 112, for later application as discussed next.

A second arrow, from server 112 to mobile device 102 shows a later point in time, where the user of mobile device 102 and computer 110 may be accessing the same account under which they were logged in when they scraped the page using computer 110. The device 102 may be programmed with content for generating a user interface for an e-mail application or a similar application. The application may be resident on the mobile device 102 or may be accessed using a browser that is resident on mobile device 102. The application for generating the interface may include a number of set interface elements and a number of variable interface elements. For example, the colors used with the application and certain logos provided with the application may be such variables. The application may look to server 112 for information about such variables and may retrieve the information when the application first launches, and plug the values of the variables into the application. In this manner, the application may take on a look that is, in certain ways, similar to that of the web page 108.

A third arrow, from mobile device 102 back to server 112, represents a saving of the formatting variables to the user's account. For example, after a user first scrapes such variables from a web page, they may be stored temporarily, and may not replace the user's existing variables. The next time that the user accesses their application, they may be asked whether they would like to try the variables on the application, and if they answer in the affirmative, the application may be launched with the variable values for the web page 108 in place of the user's normal values (though certain normal values may be retained for fixed elements, or for elements in which there was no value to be scraped from web page 108). The user may then choose to keep the settings if they like the settings, and such as signal may be communicated via the third arrow to server 112. In this manner, for example, it may be most convenient for a user to find formats that they like while they are surfing the web from their home computer, but where they cannot be sure if the formats will look good on their mobile device. They can select such formats by scraping a page for which they have permission, and then have the formats applied to their applications on the current device and on other devices they own, but only after they have had a chance to see how the formatting looks on each device.

While the user can view the webpage 108 in the mobile device 102 before selecting the website, the user can also input the web page's address into the search tool 104 and initiate a scrape command on the computer 110 or mobile device 102 without ever viewing the webpage 108. The user can also initiate a scrape command on the mobile device 102 and then have the webpage 108 displayed. Likewise, the mobile device 102 can receive style sheet information at the same time that it receives the data to display the web page 108, but before it initiates the scrape. For example, if a user views a web page 108 on her mobile device 102, the server 112 can transmit the data for the webpage 108 and the CSS file in the same transmission. In such a situation, the CSS file can be used to display a skin for an application 116 on the mobile device 102.

A user can choose a skin, which may represent formatting elements applied to provide a particular look or theme to an interface, for devices that they do not use themselves. In one implementation, a user can choose a skin for a plurality of devices. For example, a college activity leader could choose the same skin for all members of a group, and those users may be directed to information for downloading the skin to their application, such as by a URL sent by e-mail or SMS message. In another example, a company can choose its website to issue a skin for all employee devices. In yet another implementation, a user can send select a skin and then select a control, not only to add the skin to her device, but to also send a message (e.g., e-mail or text message) to a friend or group of friends so that they can easily access the information for the skin and add it to their own applications.

The same skin can be used on a plurality of applications for a user account. For example, the user can apply the same skin to an e-mail application and a calendar application. Conversely, a user can choose a different skin for each application. For example, a user may want a green skin to denote currency for a calculator application, but a yellow legal pad skin for a note-taking application. This allows the user to quickly differentiate between applications in a way that is customized to the user's needs. Likewise, if there are different users of the same device, each may have their own skin, or the device can have the same skin for all users.

FIGS. 1B and 1C show examples flows by which elements from a web page may be used in a messaging application. The figures generally show actions by which a user of a mobile device may point to a particular web page, and may then have formatting elements of that web page applied so that their messaging application includes different content than the web page, but has a similar theme as compared to the page.

The initial web page here may be a particular user's favorite page, which here is the ESPN web page having a particular font and color scheme. The user may be granted permission to use elements of the theme for their personal use, and after visiting the site every day for a long time, may wish to associate much of their user experience with ESPN. Such an association by the user may be beneficial for ESPN in that it can draw the user closer to the ESPN brand, so that ESPN may provide permission to use various elements in such a manner.

The web server 158 in this example stores mark up code for web page 160, and can be accessed by a user of mobile device 152 in a familiar manner. For example, a user of the device 152 may click on a hyperlink or otherwise have a browser 156 running on device 152 directed to a URL for the web page 160 at the web server 158. The web server 158 may respond by serving mark up code to the mobile device 152, such as in the form of HTML and style sheet code (e.g., as cascading style sheets (CSS)). The browser 156 application may then interpret the mark up code so as to render the page. The code on the web server 158 may also point generally to stories, and the page delivered to mobile device 152 may be constructed in real time so as to permit delivery of up-to-date content.

In this example, a dialog box 154 is shown to indicate that the user made a selection to re-use formatting information for page 156. For example, a contextual menu may have been selected by the user where one choice on the menu was to scrape formatting information. Such a function may be added to an existing contextual menu in a number of known manners. The user may then affirmatively select to receive the information, leading to the display of FIG. 1C which shows another application running on device 152 but using certain of the formatting information from page 156.

The HTML code received by the device 152, in this example, as shown by the arrow from server 158 to device 152 in FIG. 1C, may include textual content for the page such as the text of recent stories relating to sporting events. Such information may have been previously downloaded to the device before the web page 156 was displayed, and may be downloaded a second time to an analysis application that will identify relevant formatting data within the information, such as within a file containing CSS information for the page 156. The CSS may include formatting information, such as standard fonts and font sizes to use in rendering the content, location and padding information for groups of items, and other similar formatting information.

The browser 156 may be provided with a built-in feature or a plug-in or other type of application by which a user of the device 152 may scrape formatting information for the web page 156 after they have made their selection. For example, as described in more detail below, the application may parse through the style sheet text to identify formatting information that may be relevant to applications loaded on a user's computing device 152. The parser may work according to identified rules to extract formatting variables and map them to a corresponding location in a format definition file that can be used by other applications. As shown here, the format definition file has been built using formatting information from page 156, and results in the display of an e-mail application 162 that implements certain formatting from page 154. For example, the font for the main heading on the page may be re-used, where the heading represents the name of the page on page 154, but represents the name of the currently active e-mail account in application 162. In addition, a graphic 164 that was determined to be located on page 154 at a position close to a location in which an image is desired to be shown for the user in their e-mail application, may have been scraped, and may be re-used in the application 162.

The elements used from page 154 may also be more active. For example, certain audio files, animated elements, video feeds, RSS feeds, or other elements from a page may be moved to an application. Thus, for example, if a user shows a preference for a sports web site and an analysis program determines that the site includes a live information feed, that feed may be added automatically to a user's text messaging application under an assumption that the feed is likely to be a sporting news feed. Similar assumptions about the role played by elements on a web page may also be made, such as by analyzing extensions for elements on a page, or names of the elements, since webmasters often use descriptive names for such elements.

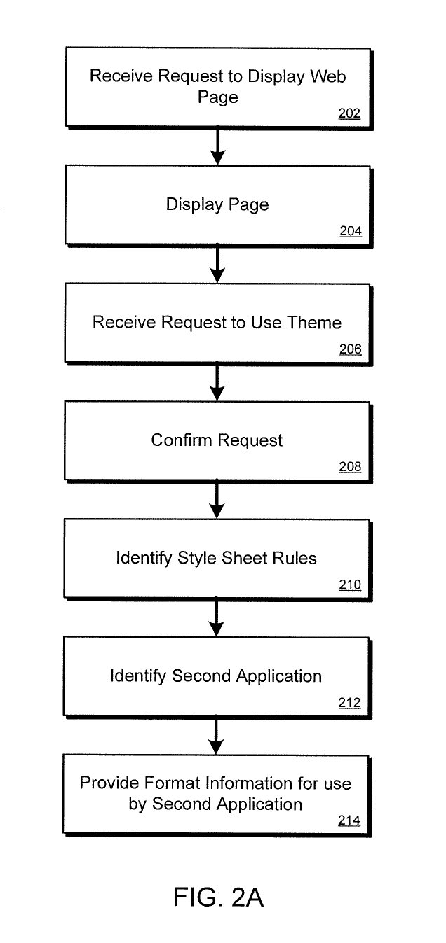

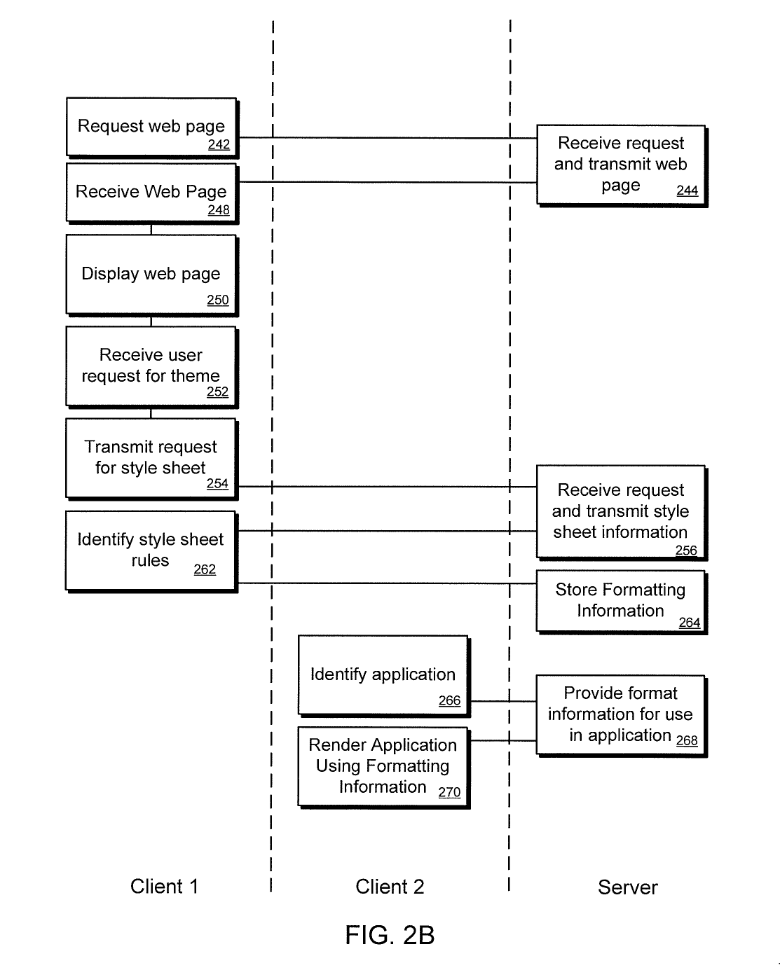

FIG. 2A is a flow chart of a process for providing formatting information from a first web page to a second web page. In general, the process involves the identification of formatting information for a page from which a user would like to re-use formatting elements, and providing the information so that another application can share certain formatting characteristics with the first page.

The process begins at box 202, where a request to display a web page is received. Such a request may take the form of an HTTP request resulting from a user selection of a hyperlink on another web page, or a user entering a URL into an address box of a standard web browser. The user's device may then display the page at box 204. Such display may occur by a web server, in response to the request for the page, providing mark-up code such as HTML code to the user's browser. The mark-up code may include references to external files such as image files and to other pages, and may also include references (e.g., in the form of URLs or URIs) to formatting information such as style sheet definitions that follow a cascading style sheets standard.

At box 206, the device receives a request from the user to use the theme from the page. The request may occur, for example, from the user selecting a particular control or menu option to have formatting information from the downloaded page re-used with another page associated with the user, or with an application running on the user's device. Upon receiving the request, the process may also confirm that the user is authorized to use the formatting information if such authorization is required. For example, the process may check for particular content in the mark up code to indicate that such re-use has been authorized by the author of the web page, and may also send a message to an address associated with the page, notifying the page owner that the information has been re-used. Generally, providers will want to permit re-use of limited formatting information so as to build a connection with users, and to thus create brand loyalty with the users.

At box 208, the process confirms the request, and at box 210 it identifies style sheet rules for the page. Generally, mark up code in the web page file will point to style sheet files that are accessed by external reference when a page loads. The application can thus look for such code that points to style sheets (e.g., by parsing for a css extension), and may separately access the style sheet code. The application can then parse through the style sheet code, as that code, like the mark-up code for the page itself, is generally in a simple textual form. For example, programmed rules may be used to identify formatting information that relates to main elements of a page, such as a background or a main heading. The values of such elements may be analyzed and extracted into a format definition file that may have sections devoted, for example, to header and background areas of other applications on the device. The particular parsing rules may be operated to match the extracted information to the information needed in the format definition file, and such information may be mapped from the style sheet text over to the format definition file. Both of the files may be formatted as simple text files, where the style sheet is in the form of a standard css file, and the format definition file can take a variety of forms, such as an XML-based text file.

As one example, a re-use application may aim to acquire information about main colors and fonts used on a page, along with certain additional identifying information. Such identifying information may include one or more images in prominent positions on a page or layout information, such as information indicating that the page is arranged to have particular menus or tabs for organizing information. The application may thus initially identify code that supplies a background color or image, and the colors and styles for fonts on the page—particularly focused on a title font and a main font used on the page. Such identified values may then be written into a format definition file under predetermined headings such as “title font,” and “main font,” “background color,” and “text color.” Other elements may be identified by parsing a DOM for the web page and traversing the DOM in known manners to identify the general organization of the page. Such analysis may, for example, permit the application to identify main elements on a page (e.g., those in more prominent positions in the DOM tree) and separate them from lesser elements located further down in the DOM tree.

Cached versions of the page may also be used to better distinguish permanent formatting information for a page from temporary content on the page. In particular, if a site provider wants its users to form a close affinity to it, it will want them to obtain page elements that have been seared into their brains, and with which they thus identify the provider, rather than elements that may have had a fleeting presence on the page, such as news stories or short-lived promotions. As a result, a re-use application may compare the current page with a cached version (or multiple versions) of the same page to identify relatively stable elements of the page, so as to use only those relatively stable elements. The comparison may occur using cached versions from various sources such as from GOOGLE cached pages or the WAYBACK MACHNE.

Once the necessary fields are filled for a format definition file, a second application may access the file. For example, an application for managing mark up code for web pages may access the file and build a style sheet and other skeleton code for a second web page that will share formatting elements with the first accessed page. Also, an e-mail program may be configured to access the formatting information when it launches, so that it takes on the formatting elements when it is rendered. Other types of application may also access the format definition file, or other form of file in which formatting information from the first web page has been stored.

The formatting information may also be accessed from multiple devices. For example, a user may have formatting information copied to a web service, and the information may be copied automatically to their various devices when they log onto the web service from those devices. Also, the applications may be web applications provided by the service, and thus may using the formatting information whenever they are generated.

The formatting information that is re-used from the initial page may be combined with other formatting information also. For example, certain display elements for an application may generally not include an analogue on web pages, so the formatting for those elements may be fixed. Also, a user may be permitted to edit the formatting information for any element or group of elements so as to override formatting that may have been extracted from a web page. In this manner, if the formatting does not translate well into another application, the user may tweak the formatting to make the application look better.

Formatting information may also be shared among users. For example, where an organization such as CNN encourages users to re-use elements of the CNN web pages (e.g., spare white background, red graphical elements, and blue text), a first user may employ an application like that described above to extract the relevant formatting information for an application. The user may then adjust the formatting information to make the look of the application more correct and pleasing. The user may then provide the data, such as through a web service, to other users for their future use with the same or similar applications. For example, a user may send a text message to a group of CNN groupies, telling them that the formatting information is available to modify the look of their various applications.

At box 214, the format information is provided for use by the second application. Such provision of the format information may occur in a variety of manners. For example, the format information may be written into a general format definition file for an application, or may be accessed in real time as the application is launched, so that the information is merged with other format information when the application is rendered. The format information may be stored locally on a client device or remotely on a server, particularly where the application is a server-based application. In this manner, the second application may be brought up to include formatting elements from the initial page, where those elements may be extracted and re-used automatically, with minimal intervention by the user (e.g., as little intervention as selecting a command to re-use the formatting elements from the initial page).

FIG. 2B is a swim lane diagram of a process for moving formatting information from one device to another. In general, the process is similar to that shown in FIG. 2A, but shows particular actions that may be taken by different components in a system where a user on a first client device identifies a web page from which they would like to re-use formatting elements, and then accesses a server-based application on another device and is presented with the application using the accessed formatting elements.

The process begins at box 242, where a first client device requests a web page such as by submitting a HTTP request including data form a URL to the internet. A server then receives the request at box 244, where the request can include a request for HTML code directly, and CSS files indirectly (e.g., because the HTML code, when loaded to the client, can request CSS files). The server then transmits the relevant web page (box 244) and related files such as image files, FLASH files, and other such files. At box 248, the first client device receives the page (i.e., receives all the relevant content for the page) and renders and displays the page at box 250.

A user of the first client device may interact with the web page in a variety of manners, such as by selecting hyperlinks on the page and then returning to the page. At some point, the user may notice that the elements on the page are open to re-use (e.g., the page may include an alert such as “Make Your Applications Look Like This Page!”), and may make a request for the theme of the page (e.g., may request the formatting elements that provide the page with its particular look). At box 252, the client device receives such a request from the user and may again obtain style sheet information from the server (boxes 254 and 256) by identifying elements in the HTML page that reference style sheet documents. Such an extra request for style sheet information may be made by an extra application running on the first client device, such as a browser plug in. As discussed above, the application may then extract formatting information by traversing style sheet rules in the style sheet, such as by identifying particular tags or labels in a style sheet, and extracted the values for variables (e.g., particular images, fonts, colors, sizes, or layout elements) that fill those tags (box 262).

The information obtained by the application may then be stored (box 264) for later use by other applications such as other web pages generated on the first client device (e.g., a generic web page may be constructed that includes the formatting elements re-used from the initial page), or by non-browser applications such as messaging applications. At box 266, such an application is identified, and at box 268, format information is provided to the other application. For example, when a user extracts format information from a web page, the application that extracts the information can identify other applications on the client device that follow a particular API for sharing format information. The extracting application can then present the user with a list of such other applications so as to permit the user to identify the other applications to which they would like to have the format information re-used. Alternatively, the extracting application may store the format information in a predetermined format, and each other application may access the stored information as appropriate. In this manner, the other applications may be rendered (box 270) to look, to some manner, like the originating page.

In this example, the other applications are presented on a second client device. In such a situation, the format information may be provided to the other applications by providing it to a central server system as soon as it is extracted, such as by a user of the first client device being logged into their personal account with a server. When the same user is later on the second client device, the same account may be accessed and the other applications for the user may be provided with the information. In certain implementations, the applications accessed on both client devices may be web-based, and thus may be essentially independent of whatever client device is used. However, in certain situations, the applications may depend on the type of device so that the particular format is changed. As one example, where the first device is a desktop computer and the second is a mobile device having a substantially smaller display, certain formatting elements may be eliminated as between applications on the first client and applications on the second client.

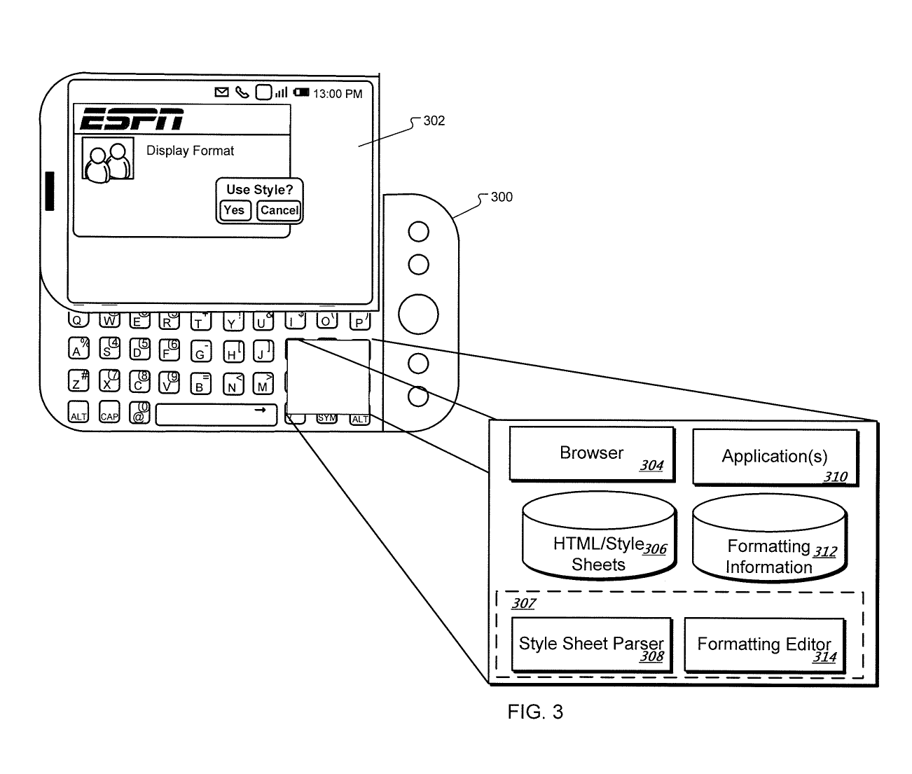

FIG. 3 is a schematic diagram 300 of a wireless communication handset 302 for generating requests and receiving and using information generated in response to those requests. In general, the handset 302 includes software stored on the device and running on a common microprocessor that is configured to extract formatting information from web pages and to provide the information on other web pages and with other applications.

The device includes a touchscreen display 302 on which may be shown various applications via a graphical user interface (GUI). The applications may likewise receive input through the display 302, or through other mechanisms such as a clickable trackball, keyboard, or softkeys.

Various components may be provided on the device for storing data and executing programs on a microprocessor to enable the operation of various applications and display of web pages under common formats or themes. For example, a web browser 304 may take a familiar form, such as the CHROME, FIREFOX, SAFARI, or INTERNET EXPLORER browsers. The browsers, when accessing web pages may download mark up code and may store such code in the HTML/style sheets storage 306, which may be a location in memory where text files for web pages are stored for manipulation and rendering by the browser 304.

The HTML code and style sheets may also be accessed by a web page format extractor 307 which may be programmed to analyze files defining formats for the various web pages displayed by the browser 304, and to extract certain formatting information from the files. Such files may include HTML files and CSS files. The extractor 307 may use a style sheet parser 308 to traverse the text for a style sheet, such as a CSS, and identify tags The parsing may involve identifying the various rules in a stylesheet and determining which of the rules has primary responsibility for the look of a page. In particular, rules relating to fonts and colors that predominate on a page may be identified initially, and the values from those rules may be extracted from the style sheet information.

A formatting editor 314 may take the values extracted from a style sheet and reformat the values so that they are useful with other applications, such as with other web pages. For example, the formatting editor 314 may parse color values from a style sheet and add them at appropriate locations in a preexisting formatting list that is to be used by other applications. Also, the formatting editor 314 may generate code using the formatting values, such as by automatically generate a shell web page having basic formatting and generic content that a user of the device may readily modify to become a complete page. For example, filler content may be provided for headings and paragraphs, and a user can paste content into those fields, where the color, font, and layout of the page has already been dictated by the formatting information from another web page.

The formatting editor 314 may store formatting information that it has parsed and modified in a formatting information data store 312, which may in turn be accessed by various applications 310 on the handset 300. The formatting information may represent values for various fields that can be used to affect the look of a variety of programs, such as in the manner that a theme may be used in an operating system to change the look of multiple applications—and the formatting information may be stored in the same location as theme data for an operation system (i.e., formatting information from a web page may overwrite values for formatting information that already exists from an operating system theme). Thus, when one of the applications 310 is launched, it may be programmed to reference the formatting information data store 312 to obtain values for various formatting parameters, such as to control the colors, fonts, and layout of programs like messaging programs and mapping programs. The values for formatting parameters may be imported as the application launches, so that the application bears visual similarity to the web page form which the values were extracted.

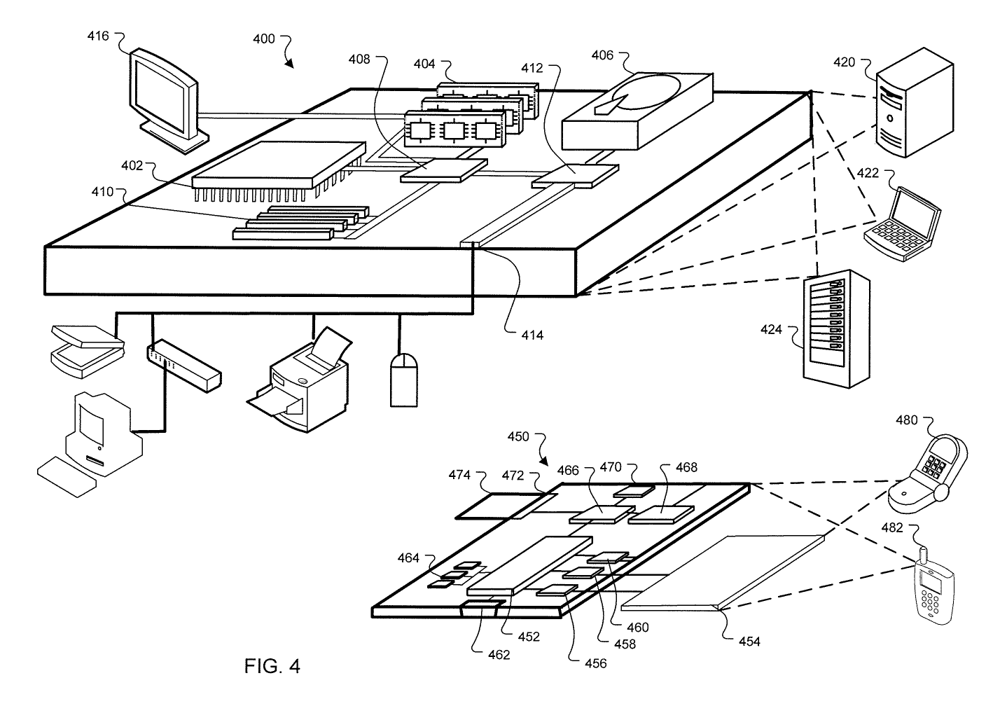

FIG. 4 shows an example of a generic computer device 400 and a generic mobile computer device 450, which may be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, memory on processor 402, or a propagated signal.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, the user may select a portion of the style sheet to apply to one or more applications on the user device. For example, the user can select the font from a style sheet. Similarly, the user can select formatting information relating to a color scheme, such as text color and background color.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method, comprising:
electronically displaying a web page with a web browser to a user of a first computing device, the web page comprising a first set of content and formatting information applied by the web browser to format the first set of content;
receiving a selection from the user in the web browser;
extracting formatting information from the displayed web page based on the selection from the user;
using the formatting information by automatically applying the formatting information to one or more applications associated with a user of the first computing device, wherein automatically applying includes automatically applying the captured formatting information to a second set of content that is selected by the user and is different from the first set of content; and
in response to the selection from the user, adding one or more key words associated with content of the web page to a personal index for the user, wherein the personal index affects search results presented to the user.

2. The method of claim 1, wherein receiving a selection from the user comprises receiving a user command on the web page to display a contextual menu and receiving a user selection of a format capture command from the menu.

3. The method of claim 1, further comprising displaying the one or more applications with formatting generated from the formatting information.

4. The method of claim 3, wherein the formatting for the one or more applications is obtained by accessing an on-line user account for a user of the first computing device.

5. The method of claim 4, wherein the one or more applications are operated on a second computing device that is different from the first computing device.

6. The method of claim 1, further comprising accessing one or more prior versions of the web page to identify elements consistent across multiple versions of the web page, and extracting formatting information for web page elements determined to be consistent across multiple versions of the web page.

7. The method of claim 1, further comprising storing the formatting information on a central server and accessing the formatting information upon launching a one or more hosted applications.

8. The method of claim 7, wherein the one or more hosted applications are each associated with a common user account, and the stored formatting information is associated with the account.

9. The method of claim 1, wherein capturing formatting information from the web page comprises traversing rules in a cascading style sheet for the web page.

10. The method of claim 1, further comprising presenting to the user a list of applications and receiving from the user a selection of applications to which the formatting is to be applied.

11. A computer-implemented system in a computing device, comprising:
a web browser to display web pages and apply formatting information to the content of the web pages on the computing device;
style sheet storage storing the formatting information for the displayed web pages;
a web page format extractor to receive a user command to extract formatting information from a web page, to access the style sheet storage and identify values for formatting in the displayed web pages, and to automatically make the values available for use by applications other than the web browser, wherein the formatting includes automatically applying the extracted formatting information to content that is selected by the user and different from content in the web pages from which the formatting information is extracted; and
a search application to determine content of the web page and to add one or more key words associated with the content to a personal index for the user, wherein the personal index affects search results presented to the user.

12. The system of claim 11, wherein the web page format extractor comprises a style sheet parser to extract information from a style sheet for a web page and a formatting editor to convert information obtained by the style sheet parser into a form that is usable by a plurality of applications on a device running the web browser.

13. The system of claim 12, further comprising one or more applications programmed to access the information obtained by the style sheet parser and apply the information to generate applications that share formatting characteristics with the web page.

14. The system of claim 12, wherein the style sheet parser is programmed to generate a user-selectable control that, when selected, causes formatting information to be parsed automatically from a web page that is currently displayed by the browser.

15. The system of claim 12, further comprising a server remote from the computing device, wherein the web page format extractor is programmed to provide formatting information from a web page to the remote server along with an identifier for an account of the user.

16. The system of claim 12, wherein the web page format extractor is programmed to access one or more prior versions of a web page to identify elements consistent across multiple versions of the web page, and to extract formatting information for web page elements determined to be consistent across multiple versions of the web page.

17. The system of claim 12, wherein the style sheet parser is programmed to traverse rules in a cascading style sheet for the web page.

18. The system of claim 12, wherein the computing device displays the values for formatting and receives a selection of at least one of the elements of the values to automatically apply the at least one of the selected elements to applications other than the web browser.

19. A computer-implemented system in a computing device, comprising:
a web browser to display web pages and apply formatting information to the content of the web pages on the computing device;
style sheet storage storing the formatting information for the displayed web pages;
means for receiving a selection from a user in the web browser;
means for automatically extracting the formatting information from the style sheet storage based on the selection from the user, and making the formatting information available for use by applications other than the web browser;
means for determining content of the selection;
means for adding one or more key words associated with content of the selection to a personal index for the user wherein the personal index affects search results presented to the user; and
an application programmed to re-use formatting information by automatically applying the formatting information to content that is selected by the user, and different from content in the web pages from which the formatting information is extracted.

20. The system of claim 19, further comprising a formatting information data store accessible by one or more applications and storing data for generating application user interfaces that match formatting elements from one or more web pages.
